(19) United States
(12) Patent Application Publication
(10) Pub. No.: US 2016/0269478 A1
(43) Pub. Date: Sep. 15, 2016

(54) PARCEL DELIVERY MONITORING SYSTEM

(71) Applicant: Davina Joanna STOCH, Johannesburg (ZA)

(72) Inventor: Davina Joanna STOCH, Johannesburg (ZA)

(21) Appl. No.: 15/030,873

(22) PCT Filed: Sep. 17, 2014
(86) PCT No.: PCT/ZA2014/000050

§ 371 Date: Apr. 21, 2016

(30) Foreign Application Priority Data
Oct. 29, 2013 (ZA) 2013/08090

(51) Int. Cl. H04L 29/08; H04W 4/04; H04L 12/58

(52) U.S. Cl. CPC H04L 67/104; H04L 51/04; H04W 4/046; H04L 67/02

(57) ABSTRACT

A parcel delivery monitoring system, comprising a server connected to a network, the server communicable with a remote computer device, system enabled to allow the computer device to place an online order for a parcel collection and tracking of said parcel until delivery, wherein at least one of the sender and receiver of the parcel are notified at milestones between collection and delivery. The notifications are generated by the system and electronically sent by at least one of email, sms, voicemail to user-inputted contact details stored on the system.

This invention relates to a parcel delivery monitoring system and in particular the method of monitoring such parcel from collection to delivery.

### BACKGROUND OF THE INVENTION

When sending a parcel by courier, it is often imperative for either the sender or intended recipient to know the location of the parcel and ideally when the parcel will be delivered. This is of particular importance when waiting for a parcel to be collected or delivered as the relevant party may not always be available to hand over or receive the parcel, as the case may be, resulting in unwanted and unforeseen delivery delays.

Current systems enable a sender and intended recipient to view the progress of a delivery at predetermined milestones such as collection time, delivery time and arrival at processing hub. This is done by either contacting the relevant courier company by phone, email or logging on to the courier's website and inputting the waybill information.

The aforementioned tracking systems require the users to pull information from the courier and do not allow real-time tracking of the parcel. These systems do not proactively update the sender or recipient as and when such crucial milestones are achieved, nor do they indicate when material delivery delays are likely. In addition, the waybill information may not be readily available when the sender or recipient requires a delivery progress update. By example, the waybill may only be trackable online and the recipient has no internet access at that moment.

It is an object of the invention to at least partially ameliorate the abovementioned disadvantages associated with monitoring the delivery of parcels utilizing courier systems.

### SUMMARY OF THE INVENTION

According to the invention there is provided a parcel delivery monitoring system, comprising a server connected to a network, the server communicable with a remote computer device, system enabled to allow the computer device to place an online order for a parcel collection and tracking of said parcel until delivery, wherein at least one of the sender and receiver of the parcel are notified at milestones between collection and delivery.

Conveniently the notifications are generated by the system and electronically sent by at least one of email, sms, voicemail to user-inputted contact details stored on the system.

Conveniently the system generates an identification code which is transmitted to at least the parcel receiver, the receiver being required to provide the delivery person with the identification code in order to take delivery of the parcel. The identification code may be provided to the delivery person orally, alternately by inputting the code into the mobile communication device (MCD) of the delivery person.

Conveniently the system is in communication with a traffic monitoring system to provide delivery notification updates to the MCD proximal and associated with a delivery person, wherein the notifications include plotting the most expeditious delivery route.

Conveniently when multiple deliveries are required, the system is enabled to communicate with a traffic monitoring system to provide delivery notification updates to the MCD, wherein the notifications include plotting the most expeditious delivery route based on priorities allocated to the collection or delivery of a parcel.

Conveniently the system is enabled to dynamically receive priority updates and delivery possibility parameters, whilst the parcel is in transit, wherein a revision in the parcel priorities causes the system to automatically recalculate and plot the delivery route for a delivery person.

Conveniently the system is enabled to transmit expected time of deliver notifications based on the driver's route schedule and traffic conditions. In particular, a notification may be sent when expected delivery times are materially affected by unexpected traffic events such as vehicle accidents and ad-hoc road blocks.

Preferably, the system is enabled to determine whether a parcel in transit with a first driver would be more suitably delivered by a second driver based on the second driver's delivery schedule and route. In such instance, a suitable rendezvous notification is transmissible to the MCD of both delivery persons advising which parcel is being transferred. The transfer would be included in the tracking notifications sent.

Conveniently the system is enabled to require confirmation of a specific recipient before the parcel is released by the delivery person to the recipient. Such confirmation may include at least one of biometric, identity document or password confirmation.

According to another aspect of the invention, the system is enabled to generate a tender notification to drivers connected thereto by MCDs, whereby the system transmits a notification to MCDs in the proximity of the intended collection, advising the delivery persons of the collection and delivery details. Accordingly, the closest appropriate and available driver is able to collect the parcel in the quickest time.

Conveniently the system would require the driver being awarded the tender to confirm acceptance of the tender and collection thereof by following prompts transmitted to his MCD. Driver details and expected collection time notifications would thereafter be transmitted in accordance with user inputted details.

Conveniently the system is enabled to restrict transmission of tenders to specific recipients. Tender restriction is determined by at least one of delivery person proximity, delivery person delivery schedule, priority of parcel, type of parcel, rating of delivery person. The rating of the delivery person is affected by delivery quality and quantity over period of time. The rating may be affected by user and or system administrator rating history.

Conveniently system users are able to communicate with one another by logging on to the system. Communication may include at least one of voice, visual or text.

Further features, variants and/or advantages of the invention will emerge from the following non-limiting description of an example of the invention.

### DETAILED DESCRIPTION OF THE INVENTION

The invention provides an electronic parcel delivery monitoring system, comprising a server connected to a network, the server communicable via the internet with a remote computer device of a user wishing to request a parcel collection and delivery, the system having enabling software and hardware to allow the computer device of the user to place an online order for a parcel collection and tracking of said parcel until delivery, wherein at least one of the sender and receiver of the parcel are notified at milestones between collection and delivery. The required information is inputted by the user following prompts generated by the system user interface to generate a collection and delivery request log.

The notifications are generated by the system and electronically sent by at least one of email, sms or voicemail to user-inputted contact details stored on the system. These contact details may be selected and inputted from prior inputted information associated with the user, alternately inputted at time of logging a collection order.

The system is in real-time communication with a traffic monitoring system to provide delivery notification updates to the a mobile communication device (MCD) such as a tablet or smart phone, proximal and associated with a delivery person, wherein the notifications include plotting the most expeditious delivery route based on a delivery schedule allocated to the driver by the system. The delivery schedule is automatically populated and updated when a user logs a collection request. The system is programmed to assign a logged collection request to a specific driver based on various delivery parameters including location of driver, collection address, delivery address, remaining parcel capacity of driver's vehicle, traffic affecting driver's route, priority of collection and delivery, restriction of collection and or delivery times, and time availability of driver. The system provides for dynamic scheduling updates. This occurs when the system receives priority updates and delivery possibility parameters, whilst the parcel is in transit. A revision in the parcel priorities and factors affecting the delay in collecting or delivering a parcel causes the system to automatically recalculate and plot the delivery route for a delivery person. By example, if severe traffic congestion occurs due to an accident, the system may reassign one or more deliveries from driver A to driver B. The relevant drivers would receive a notification to their MCD advising them of the rescheduling and guide them to the next collection or delivery. This is achieved by the system plotting the most expeditious delivery route based on priorities allocated to the collection or delivery of a parcel.

The dynamic updates enables the system to transmit expected time of delivery notifications based on the driver's route schedule and traffic conditions. In particular, a notification may be sent when expected delivery times are materially affected by unexpected traffic events such as vehicle accidents and ad-hoc road blocks. The notifications are transmitted in accordance with the user's inputted notification requirements. By example, the parcel sender, parcel recipient, system operator and a plurality of interested third parties may all be notified. Interested third parties may include police, fire or ambulance services with more relevant information being provided to the third parties. An example would be where the driver logs a voice description of an accident and takes a picture utilizing his MCD.

The incident log with GPS coordinates is then uploaded onto the system for notification transfer. The system transmits the notification to the user without the voice and photo log but with an accompanying link to download the voice and photo log if desirable.

The system is further enabled to determine whether a parcel in transit with a first driver would be more suitably delivered by a second driver based on the second driver's delivery schedule and route. In such instance, a suitable rendezvous notification is transmissible to the MCD of both drivers advising which parcel is being transferred. The transfer would be included in the tracking notifications sent.

As will be appreciated, only significant delays which conflict with required parcel delivery or collection parameters would trigger a rendezvous notification.

At delivery of the parcel, the system requires that confirmation of a specific recipient be inputted before the parcel is released by the delivery person to the recipient. Such confirmation may include at least one of biometric, identity document or password confirmation.

The following steps form one embodiment in the system:

### Initial System Contact:

The user inputs details to sign-up and is required to accept terms and conditions prompts;
The system provides the user with prompts to complete and populate the required input fields;
The system thereafter checks the credit worthiness of client against suitable databases which are accessible;
The system thereafter accepts the user and generates a user code.

### Delivery Initiation

The user logs onto the system website with their login details, namely user code and password;
The required fields of a virtual waybill are populated following the system prompts. Prompts include:
   1. Collection address, which may be a preloaded are amendable address;
   2. Contact information of person sending the parcel (cell number and email address);
   3. Delivery address;
   4. Notification types and notification recipients required including automatic notification to sender, recipient, interested third party;
   5. Recipient details;
   6. Recipient contact details (cell number and email address);
   7. Parcel dimensions;
   8. Description of parcel contents, whereby the description is selected by means of a drop-down menu with the ability to specify non-listed descriptions;
   9. Whether insurance is required and value thereof;
   10. Value of the goods being insured;
   11. Specific handling instructions for parcel;
   12. Delivery urgency—in particular what is the required delivery date and time;
   13. Readiness of the parcel for collection, which is selected from a drop-down menu with the ability to specify time and date when parcel will be ready for collection;
The user thereafter clicks on a declaration tab confirming goods are fit for carriage as per the terms and conditions;
A delivery cost is thereafter indicated based on the delivery parameters inputted by the user and an invoice generated. Delivery cost may also be debited from a declining balance linked to the user code;
The user thereafter confirms delivery order and submits the waybill by following the appropriate prompts;
A delivery order confirmation comprising waybill details with a unique waybill number is transmitted to all parties to whom notifications are required as per the user inputted information. The confirmation includes expected delivery time and driver identity.
The user, alternately the delivery person thereafter applies the waybill information to the parcel, which parcel may be secured in a tamper-proof delivery bag. Where the parcel dimensions are greater than the delivery bag capacity—the waybill information, which includes a barcode associated therewith, is affixed to the parcel for ready identification by the delivery person.

### Delivery Person

The system processes the waybill information and selects the most suitable delivery person who is thereafter sent a notification to his MCD indicating the waybill information with collection parameters;
The MCD has a waybill interface, which is populated by the driver at specific milestones during the delivery process including collection of parcel, delivery of parcel to central processing hub, dispatch of parcel from central processing hub, delivery of parcel;
The MCD of the delivery person has mapping software to enable plotting of the most appropriate route. The route is updatable in real-time to ensure dynamic selection of the most appropriate route, which may be varied depending on a plurality of parameters including delivery schedule, traffic congestion and urgency of parcel delivery;
Where a material change of delivery times is expected, the system transmits updated delivery notifications in accordance with the user's requirements;
The user is able to track the exact location of the parcel in transit utilising the GPS coordinates of the delivery person, whose GPS coordinates are viewable online;
The delivery person may input additional recipient identity confirmation with relational to the waybill by using his MCD to record recipient biometric information such as retina scanning, fingerprint scanning, voice recording, taking a photo of the recipient or a combination thereof. The additional recipient identification is uploaded on to the system. Identity notifications are transmitted in accordance with user requirements inputted.

It will be appreciated that the invention is not limited to the abovementioned embodiments. For example the parcel recipient identity may first be confirmed by the sender before the parcel is released. This is achieved by the delivery person taking a photo of the recipient, which is then transmitted to the sender via a delivery authorisation request notification, and whereby the sender would follow prompts to authorize the delivery. By example, the sender may be required to select an “authorize delivery” prompt sent to their cellular phone which would be transmitted to the system and subsequently to the MCD of the driver who would subsequently release the parcel. Further the system may be used by means of an app loaded onto the MCD of the driver and the computing device of the user, which provides for communication over the Internet and obviates the cost associated with sending sms's.

The claims and the summary of invention form an integral aspect of the description of the invention.

1-16.(canceled)

17. A parcel delivery monitoring system, comprising a server connected to a network, the server communicable with a remote computer device, the system having enabling software and hardware to allow the remote computer device to place an online order for a parcel collection and tracking of said parcel until delivery, wherein the system is communicable with a traffic monitoring system to provide delivery notification updates to a mobile communication device (MCD) proximal and associated with a delivery person, alternately a delivery vehicle, and wherein the notifications include plotting the most expeditious delivery route.

18. The monitoring system as claimed in claim 17, wherein the system has enabling software and hardware to communicate with a traffic monitoring system to provide delivery notification updates to the MCD; the notifications include plotting the most expeditious delivery route based on priorities allocated to the collection or delivery of a parcel.

19. The monitoring system as claimed in claim 18, having enabling software to receive priority updates and delivery possibility parameters, whilst the parcel is in transit, wherein a revision in the parcel priorities causes the system to automatically recalculate and plot the delivery route for a delivery person.

20. The monitoring system as claimed in claim 19, which has enabling software to transmit expected time of delivery notifications based on the driver's route schedule and traffic conditions.

21. The monitoring system as claimed in claim 18, having enabling software to determine whether a parcel in transit with a first driver would be more suitably delivered by a second driver based on the second driver's delivery schedule and route, wherein a suitable rendezvous notification is transmitted to the MCD of both delivery persons advising which parcel is being transferred along with delivery instructions.

22. The monitoring system as claimed in claim 18, having enabling software and hardware to require confirmation of a specific recipient before the parcel is released by the delivery person to the recipient.

23. The monitoring system as claimed in claim 22, having enabling software and hardware to require confirmation of a specific recipient before the parcel is released by the delivery person to the recipient.

24. The monitoring system as claimed in claim 23, wherein such confirmation includes at least one of biometric, identity document or password confirmation as recorded on the system.

25. The monitoring system as claimed in claim 19, having enabling software to generate a tender notification to delivery persons connected thereto by MCDs, whereby the system transmits a notification to MCDs in the proximity of the intended collection, advising the delivery persons of the collection and delivery details and awarding the tender to the closest appropriate and available driver.

26. The monitoring system as claimed in claim 25, having enabling software to generate a tender notification to delivery persons connected thereto by MCDs, whereby the system transmits a notification to MCDs in the proximity of the intended collection, advising the delivery persons of the collection and delivery details and awarding the tender to the closest appropriate and available driver.

27. The monitoring system as claimed in claim 26, wherein the system having enabling software would require the driver being awarded the tender to confirm acceptance of the tender and collection thereof by following prompts transmitted to his MCD.

28. The monitoring system as claimed in claim 27, wherein driver details and expected collection time notifications are thereafter transmitted in accordance with user notification criteria.

29. The monitoring system as claimed in claim 26, wherein the system has enabling software to restrict transmission of tenders to specific recipients.

30. The monitoring system as claimed in claim 29, wherein tender restriction is determined by at least one of delivery person proximity, delivery person delivery schedule, priority of parcel, type of parcel, rating of delivery person.

31. The monitoring system as claimed in claim 29, wherein the delivery person has a rating which is determined by delivery quality and quantity over period of time.

32. The monitoring system as claimed in claim 29, wherein the system has enabling software for the user to select the delivery person.

33. The monitoring system as claimed in claim 32, wherein the system has enabling software to provide the user a plurality of delivery persons and wherein the user determines which delivery person the tender is awarded.
